(19) United States
(12) Patent Application Publication
(10) Pub. No.: US 2025/0301481 A1
(43) Pub. Date: Sep. 25, 2025

(54) MULTIPLEXING A PLURALITY OF SEARCH SPACES WITHIN A CONTROL RESOURCE SET

(71) Applicant: Lenovo (United States) Inc., Morrisville, NC (US)

(72) Inventors: Karthikeyan Ganesan, Nauheim (DE); Ali Ramadan Ali, Kraiburg am Inn (DE); Ravi Kuchibhotla, Chicago, IL (US)

(21) Appl. No.: 19/230,978

(22) Filed: Jun. 6, 2025

(51) Int. Cl. H04W 72/231; H04J 13/00; H04L 5/00; H04W 72/044

(52) U.S. Cl. CPC H04W 72/231; H04J 13/004; H04L 5/0051; H04W 72/044

(57) ABSTRACT

Various aspects of the present disclosure relate to multiplexing search spaces within a control resource set (CORESET). A base station can map a first search space and a second search space to a first CORESET corresponding to a physical downlink control channel (PDCCH). Additionally, the base station can multiplex, using a code-division multiplexing technique, a first PDCCH symbol and a second PDCCH symbol. The first PDCCH symbol can be transmitted in the first search space of the first CORESET and the second PDCCH symbol can be transmitted in the second search space of the first CORESET. Moreover, the base station can transmit, using the first search space of the first CORESET, the first PDCCH symbol to a first set of user equipments (UEs). Furthermore, the base station can transmit, using the second search space of the first CORESET, the second PDCCH symbol to a second set of UEs.

### TECHNICAL FIELD

The present disclosure relates to wireless communications, and more specifically to multiplexing of plurality of search spaces within a control resource set (CORESET) for a physical downlink control channel (PDCCH) transmission.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

The devices (e.g., NE, UE), processors, and methods of the present disclosure each have several innovative aspects, no single one of which is solely responsible for the desirable features disclosed herein.

A NE (e.g., base station) for wireless communication is described. The base station may be configured to, capable of, or operable to perform one or more operations as described herein. For example, the base station may be configured to, capable of, or operable to map a first search space and a second search space to a first CORESET. The CORESET spans a first set of time-frequency resources that corresponds to a PDCCH which carries a plurality of PDCCH symbols. Additionally, the base station can multiplex, using a code-division multiplexing technique, a first PDCCH symbol and a second PDCCH symbol. The first PDCCH symbol can be transmitted in the first search space of the first CORESET and the second PDCCH symbol can be to be transmitted in the second search space of the first CORESET. Moreover, the base station can transmit, using the first search space of the first CORESET, the first PDCCH symbol to a first set of UEs configured to monitor the first search space. Furthermore, the base station can transmit, using the second search space of the first CORESET, the second PDCCH symbol to a second set of UEs configured to monitor the second search space.

In some instances, multiplexing using the code-division multiplexing technique can include applying a first orthogonal cover code (OCC) to the first PDCCH symbol and applying a second OCC to the second PDCCH symbol.

In some instances, the first PDCCH symbol can include a first downlink control information (DCI) codeword and the second PDCCH symbol includes a second DCI codeword. Additionally, multiplexing using the code-division multiplexing technique can include applying a first OCC to the first DCI codeword and applying a second OCC to the second DCI codeword.

In some instances, the first PDCCH symbol can include a first DCI codeword and the second PDCCH symbol can include a second DCI codeword. Additionally, multiplexing using the code-division multiplexing technique can include multiplying the first DCI codeword with a first binary sequence. Moreover, multiplexing using the code-division multiplexing technique can further include multiplying the second DCI codeword with a second binary sequence. Furthermore, the first binary sequence can be orthogonal to the second binary sequence.

In some instances, the first PDCCH symbol and second PDCCH symbol can be made orthogonal by using code-division multiplexing in a time domain.

In some instances, the first PDCCH symbol and second PDCCH symbol can be made orthogonal by using code-division multiplexing in a frequency domain.

In some instances, the first PDCCH symbol and the second PDCCH symbol can be made orthogonal by using code-division multiplexing in a combination of a time domain and a frequency domain.

In some instances, the base station can map a first search space group to the first CORESET. The first search space group can have the first search space, the second search space, and a third search space. Additionally, each search space in the first search space group is associated with a unique OCC (e.g., first search space can be associated with a first OCC, second search space can be associated with a second OCC, third search space can be associated with a third OCC). Moreover, the base station can map a second search space group to a second CORESET. The second search space group can also have a plurality of search spaces. Furthermore, the first CORESET and the second CORESET can be transmitted in a first time slot.

In some instances, the first PDCCH symbol can be transmitted using a first spatial beam and the second PDCCH symbol can be transmitted using a second spatial beam. Additionally, the base station can map a first demodulation reference signal (DMRS) sequence associated with the first search space to a first antenna port. Moreover, the base station can map a second DMRS sequence associated with the second search space to a second antenna port. In one example, the first DMRS sequence and the second DMRS sequence can be made orthogonal by using code-division multiplexing in a time domain. In another example, the first DMRS sequence and the second DMRS sequence can be made orthogonal by using code-division multiplexing in a frequency domain. In yet another example, the first DMRS sequence and the second DMRS sequence can be made orthogonal by using code-division multiplexing in a combination of a time domain and a frequency domain.

In some instances, the first PDCCH symbol and the second PDCCH symbol can be transmitted using a first spatial beam. Additionally, the base station can map a first DMRS sequence to the first search space after multiplexing the first PDCCH symbol and the second PDCCH symbol. Moreover, the base station can map the first DMRS sequence to the second search space.

In some instances, the first search space can include a plurality of overlapping control channel element (CCE) indices with the second search space. Additionally, the base station can configure a bitmap. The bitmap can include a bit associated with each CCE index in the plurality of overlapping CCE indices. Moreover, multiplexing using the code-division multiplexing technique can include multiplexing the first PDCCH symbol and the second PDCCH symbol based on the bitmap.

In some instances, the first search space can include a plurality of CCE indices. Additionally, multiplexing using the code-division multiplexing technique can include multiplexing the first PDCCH symbol for a subset of the plurality of CCE indices in the first search space.

In some instances, the base station can configure a PDCCH configuration. The PDCCH configuration can have an first OCC for the first search space and a second OCC for the second search space.

A processor (e.g., a standalone processor chipset, or a component of a NE) for wireless communication is described. The processor may be configured to, capable of, or operable to perform one or more operations as described herein. For example, the processor may be configured to, capable of, or operable to map a first search space and a second search space to a first CORESET. The CORESET spanning a first set of time-frequency resources that corresponds to a PDCCH which carries a plurality of PDCCH symbols. Additionally, the processor can multiplex, using a code-division multiplexing technique, a first PDCCH symbol and a second PDCCH symbol. The first PDCCH symbol can be transmitted in the first search space of the first CORESET and the second PDCCH symbol can be to be transmitted in the second search space of the first CORESET. Moreover, the processor can transmit, using the first search space of the first CORESET, the first PDCCH symbol to a first set of UEs configured to monitor the first search space. Furthermore, the processor can transmit, using the second search space of the first CORESET, the second PDCCH symbol to a second set of UEs configured to monitor the second search space.

A method performed or performable by a NE for wireless communication is described. The method may include mapping a first search space and a second search space to a first CORESET. The CORESET spanning a first set of time-frequency resources that corresponds to a PDCCH which carries a plurality of PDCCH symbols. Additionally, the method can include multiplexing, using a code-division multiplexing technique, a first PDCCH symbol and a second PDCCH symbol. The first PDCCH symbol can be transmitted in the first search space of the first CORESET and the second PDCCH symbol can be to be transmitted in the second search space of the first CORESET. Moreover, the method can include transmitting, using the first search space of the first CORESET, the first PDCCH symbol to a first set of UEs configured to monitor the first search space. Furthermore, the method can include transmitting, using the second search space of the first CORESET, the second PDCCH symbol to a second set of UEs configured to monitor the second search space.

A UE for wireless communication is described. The UE may be configured to, capable of, or operable to perform one or more operations as described herein. For example, the UE may be configured to, capable of, or operable to receive configuration information. The configuration information can indicate that a first search space and a second search space are mapped to a first CORESET. The first CORSET can span a first set of time-frequency resources that corresponds to a PDCCH which carries a plurality of PDCCH symbols. The configuration information can include an orthogonal code for multiplexing a first PDCCH symbol that is transmitted in the first search space. Additionally, the UE can receive, based on monitoring the first search space, the first PDCCH symbol. Moreover, the UE can decode, using the orthogonal code, the first PDCCH symbol.

In one example, the configuration information can be PDCCH configuration information. In another example, the configuration information can be CORESET configuration information. In yet another example, the configuration information can be search space configuration information.

In some instances, the configuration information can include a number of occurrences where the first PDCCH symbol is transmitted by a base station. Additionally, the UE can decode the first PDCCH symbol using an OCC after the first PDCCH symbol has been received the number of occurrences.

A processor (e.g., a standalone processor chipset, or a component of a NE) for wireless communication is described. The processor may be configured to, capable of, or operable to perform one or more operations as described herein. For example, the processor may be configured to, capable of, or operable to receive configuration information. The configuration information can indicate that a first search space and a second search space are mapped to a first CORESET. The first CORSET can span a first set of time-frequency resources that corresponds to a PDCCH which carries a plurality of PDCCH symbols. The configuration information can include an orthogonal code for multiplexing a first PDCCH symbol that is transmitted in the first search space. Additionally, the processor can receive, based on monitoring the first search space, the first PDCCH symbol. Moreover, the processor can decode, using the orthogonal code, the first PDCCH symbol.

A method performed or performable by a NE for wireless communication is described. The method may include receiving configuration information. The configuration information can indicate that a first search space and a second search space are mapped to a first CORESET. The first CORSET can span a first set of time-frequency resources that corresponds to a PDCCH which carries a plurality of PDCCH symbols. The configuration information can include an orthogonal code for multiplexing a first PDCCH symbol that is transmitted in the first search space. Additionally, the method can include receiving, based on monitoring the first search space, the first PDCCH symbol. Moreover, the method can include decoding, using the orthogonal code, the first PDCCH symbol.

### BRIEF DESCRIPTION OF THE DRAWINGS

FIG. 1 illustrates an example of a wireless communications system in accordance with aspects of the present disclosure.

FIG. 2 illustrates a communication flow diagram for multiplexing a plurality of search spaces in a CORESET in accordance with aspects of the present disclosure.

FIG. 3 illustrates an example mapping of control resource allocation and signaling flow in a 5G NR system implementation in accordance with aspects of the present disclosure.

FIG. 4 illustrates an example dataflow implementation of PDCCH multiplexing with OCC in accordance with aspects of the present disclosure.

FIG. 5 illustrates an example implementation of inter-slot mapping in accordance with aspects of the present disclosure.

FIG. 6 illustrates an example implementation of intra-slot mapping in accordance with aspects of the present disclosure.

FIG. 7 illustrates an example implementation of inter-slot frequency domain mapping in accordance with aspects of the present disclosure.

FIG. 8 illustrates an example of a UE in accordance with aspects of the present disclosure.

FIG. 9 illustrates an example of a processor in accordance with aspects of the present disclosure.

FIG. 10 illustrates an example of an NE in accordance with aspects of the present disclosure.

FIG. 11 illustrates a flowchart of method performed by a UE in accordance with aspects of the present disclosure.

FIG. 12 illustrates a flowchart of method performed by a NE in accordance with aspects of the present disclosure.

### DETAILED DESCRIPTION

The present disclosure relates to wireless communication systems and addresses limitations in the capacity and reliability of physical downlink control channel (PDCCH) transmission in 5G networks. In some wireless communications systems supporting 5G, control resource sets (CORESETs) are configured to define time and frequency resources for a PDCCH transmission. PDCCH transmission carries downlink control information (DCI) that schedules data and control channels and it is transmitted within a CORESET. The CORESET defines where and how the PDCCH is mapped, by configuring the time, frequency, and antenna domain resources of a PDCCH transmission. Additionally, search spaces are assigned to a set of UEs for PDCCH candidate monitoring. To improve control channel reliability, especially for UEs deployed in challenging coverage scenarios (such as low-power wide-area devices), network nodes often repeat PDCCH transmissions or use higher aggregation levels. This approach, however, can consume a larger number of limited PDCCH control channel elements (CCEs), block additional scheduling opportunities, and reduce PDCCH capacity for other users.

To address these issues, the present disclosure provides a technique for increasing PDCCH capacity during repetition or coverage-improving operations by multiplexing multiple PDCCH transmissions within a CORESET using code-division multiplexing (CDM). For example, the base station can map a plurality of search spaces to a single CORESET. Additionally, the base station can multiplex respective PDCCH symbols from different search spaces using orthogonal cover codes (OCCs) or other orthogonal sequences. The base station can then transmit the multiplexed symbols over the same time-frequency resources, thereby allowing more efficient use of the available control channel resources. In some implementations, the OCCs can be applied to PDCCH symbols, CORESET symbols, search space symbols, or directly to encoded downlink control information (DCI) codewords prior to mapping to radio resources.

An example technical problem solved by example implementations of aspects of the present disclosure may include control channel resource exhaustion due to PDCCH repetition and high aggregation levels. In conventional wireless base station operation, attempts to improve reliability of PDCCH transmission for UEs—such as low-power or coverage-challenged devices—often leverage repetition and high aggregation levels, consuming a disproportionate share of the available CCEs within CORESETs. This can result in blocking additional control transmissions, create scheduling bottlenecks, and directly undermine the ability of the network to simultaneously support timely delivery of control information to other UEs. For instance, when multiple repetitions or heavily aggregated PDCCHs target a single UE, the fixed-size CORESET can quickly be exhausted, preventing scheduling of other UEs, thus decreasing overall control channel efficiency and degrading network responsiveness. Example implementations of aspects of the present disclosure may provide technical solutions to this problem by enabling the multiplexing of multiple PDCCH symbols, for different search spaces and UEs, within a single CORESET using CDM techniques such as OCCs. This approach allows the base station to encode and superpose several control channel transmissions over the same set of physical time-frequency resources, such that each can be distinguished by their orthogonal code. As a result, even under scenarios where traditional scheduling would require allocating non-overlapping or repeated CCEs (thereby consuming more overall resources), the base station can deliver repeated or coverage-enhanced PDCCHs without monopolizing the available resource set, leaving room for scheduling other users efficiently and flexibly. The technology described explicitly increases the number of effective control channel transmissions possible within a fixed CORESET by leveraging code-domain separation in addition to conventional time-frequency resource allocation.

By allowing CCE indices to be shared across repeated, aggregated, or overlapping search spaces while still maintaining reliability via OCC-based orthogonality, the claimed solution prevents resource starvation, avoids scheduling deadlock, and improves utilization of available control region bandwidth. Further, because the separation of control signaling for different UEs is achieved at the physical layer through OCCs, there is no reduction in transmission robustness for the coverage-challenged UEs: the same number of repetitions or aggregation levels may be maintained, but the resource penalty is mitigated by enabling parallel, non-interfering transmissions to other UEs in the same region. The base station can include configurable processors and memory for mapping OCCs to PDCCHs per search space and per CCE, as well as logic to dynamically adapt resource multiplexing in real time. The UEs are correspondingly configured to receive, buffer, and de-spread OCC-multiplexed PDCCH signals, recovering intended control information even in the presence of simultaneous transmissions. These functional steps directly address the practical bottleneck of control channel element exhaustion and thus yield a more scalable and reliable wireless communication infrastructure.

Another example technical problem solved by example implementations of aspects of the present disclosure may include limited capacity for simultaneous control signaling to multiple UEs. In prior wireless systems, constraints on CORESET size and the rules requiring non-overlapping or orthogonal assignment of control channel candidate resources (e.g., search spaces) led to frequent scheduling bottlenecks. When multiple UEs require concurrent or repeated downlink control channel signaling, overlap and collision of control information in the control region impede the ability to reliably convey necessary scheduling information, resulting in higher latency, missed grants, or failed handover and resource allocation procedures. Example implementations of aspects of the present disclosure may provide technical solutions to this problem by supporting the assignment and OCC-based multiplexing of multiple search spaces—associated with distinct UEs or UE groups—to a shared CORESET. Through code-division multiplexing, multiple PDCCH transmissions to different UEs can be transmitted simultaneously in the same time-frequency region of the control bandwidth. Each PDCCH transmission is processed with a different orthogonal cover code, permitting reliable separation and detection by the respective targeted UEs, even where their PDCCH monitoring regions overlap entirely or partially. This can remove the prior technical limitation of strict non-overlap, as interference between simultaneous control transmissions is suppressed in the code domain rather than solely in the resource domain. This functional mechanism fundamentally increases the control signaling density of the shared medium. By mapping a plurality of search spaces to a single CORESET, the base station can serve more UEs per scheduling interval within the same bounding region of physical resources. Importantly, each UE is able to monitor and successfully decode its intended PDCCH message—through de-spreading and code-matched processing—without an increased collision risk. This leads directly to improvements in both control channel throughput and latency, as well as better fairness among UEs in terms of scheduling opportunities during periods of contention.

Another example technical problem solved by example implementations of aspects of the present disclosure may include inflexibility and resource waste caused by rigid, non-overlapping search space and CCE assignments in the control channel. Traditional mechanisms require either static or strictly non-overlapping allocation of search spaces to UEs to avoid intra-cell control interference, which leads directly to poor utilization of the available resource grid. When certain search spaces are only intermittently active or assigned to few UEs, their reserved bandwidth cannot be opportunistically exploited by others, resulting in spectral inefficiency and suboptimal use of precious control resources. Example implementations of aspects of the present disclosure may provide technical solutions to this problem through flexible CDM-based scheduling, wherein multiple search spaces (including idle or low-duty-cycle search spaces) can be mapped to the same CORESET, with dynamic, partial, or complete overlapping of CCE regions being permitted. Using code-division multiplexing, overlapping or shared CCE assignments no longer constitute interference, as the OCC labeling and corresponding signal processing at the receiver side maintain orthogonality between concurrent control channel transmissions. Additionally, the use of bitmap-based or dynamic configuration of CCE subsets ensures that resource allocation can track instantaneous demand, with OCC-multiplexed transmissions filling otherwise idle or lightly loaded search space allocations, adapting seamlessly to temporal fluctuations in user activity. This configurability translates to a significant boost in spectral and control channel efficiency, as the same set of physical resources can flexibly carry a greater diversity and density of control information. When a search space is inactive or underutilized, the associated resources are no longer wasted: the base station can opportunistically schedule additional control data for other UEs or services in the overlapping region, leveraging the orthogonal code map and bitmap configuration to avoid collisions. The adaptation can be made rapidly, via dynamic signaling of OCC configuration and CCE mappings, and can be tailored per UE, per traffic type, or even per instantaneous system condition.

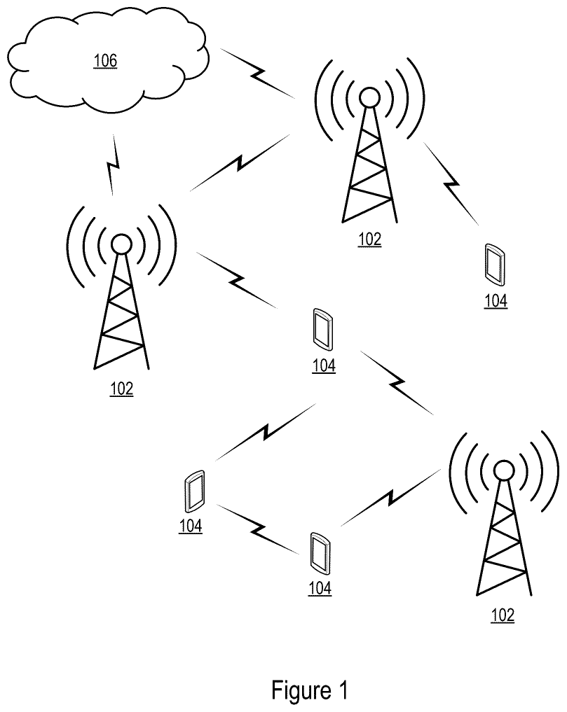

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a next-generation (NR) network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, an access point (AP), a network element, a network function, a network entity, network infrastructure (or infrastructure), a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

In some implementations, an NE 102 may be implemented in a disaggregated architecture (e.g., a disaggregated base station architecture, a disaggregated RAN architecture), which may be configured to utilize a protocol stack that may be physically or logically distributed among multiple network entities (e.g., NEs 102), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, an NE 102 may include one or more of a central unit (CU), a distributed unit (DU), a radio unit (RU), a RAN Intelligent Controller (RIC) (e.g., a Near-Real Time RIC (Near-RT RIC), a Non-Real Time RIC (Non-RT RIC)), or any combination thereof. An RU may also be referred to as a radio head, a smart radio head, a remote radio head (RRH), a remote radio unit (RRU), or a transmission reception point (TRP). The split of functionality between a CU, a DU, and an RU may be flexible and may support different functionalities depending on which functions (e.g., network layer functions, protocol layer functions, baseband functions, RF functions, or any combinations thereof) are performed at a CU, a DU, or an RU.

One or more components of the NEs 102 in a disaggregated RAN architecture may be co-located, or one or more components of the NEs 102 may be located in distributed locations (e.g., separate physical locations). Additionally, or alternatively, in some examples, one or more of the NEs 102 of a disaggregated RAN architecture may be implemented as virtual units (e.g., a virtual CU (VCU), a virtual DU (VDU), a virtual RU (VRU)).

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

The wireless communications system 100 may be configured to support ultra-reliable communications or low-latency communications, or various combinations thereof. For example, the wireless communications system 100 may be configured to support ultra-reliable low-latency communications (URLLC). The UEs 104 may support ultra-reliable, low-latency, or critical functions. Ultra-reliable communications may include private communication or group communication. Support for ultra-reliable, low-latency functions may include prioritization of services, and such services may be used for public safety or general commercial applications. The terms ultra-reliable, low-latency, and ultra-reliable low-latency may be used interchangeably herein.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a CP. A first numerology (e.g., μ=0) may be associated with a first subcarrier spacing (e.g., 15 kHz) and a normal CP. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal CP. A third numerology (e.g., μ=2) may be associated with a third subcarrier spacing (e.g., 60 kHz) and a normal CP or an extended CP. A fourth numerology (e.g., μ=3) may be associated with a fourth subcarrier spacing (e.g., 120 kHz) and a normal CP. A fifth numerology (e.g., μ=4) may be associated with a fifth subcarrier spacing (e.g., 240 kHz) and a normal CP.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal CP, a slot may include 15 symbols. For an extended CP (e.g., applicable for 60 kHz subcarrier spacing), a slot may include 12 symbols. The relationship between the number of symbols per slot, the number of slots per subframe, and the number of slots per frame for a normal CP and an extended CP may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

In some implementations, specific hardware and signal processing adaptations can be performed for both the base station and UE. For example, the base station can include configurable processors and memory for mapping OCCs to PDCCHs per search space and per CCE, as well as logic to dynamically adapt resource multiplexing in real time. The UEs are correspondingly configured to receive, buffer, and de-spread OCC-multiplexed PDCCH signals, recovering intended control information even in the presence of simultaneous transmissions. These improvements can directly address the practical bottleneck of control channel element exhaustion, widen the bottleneck that prevents timely control signaling to numerous UEs, and thus yield a more scalable and reliable wireless communication infrastructure.

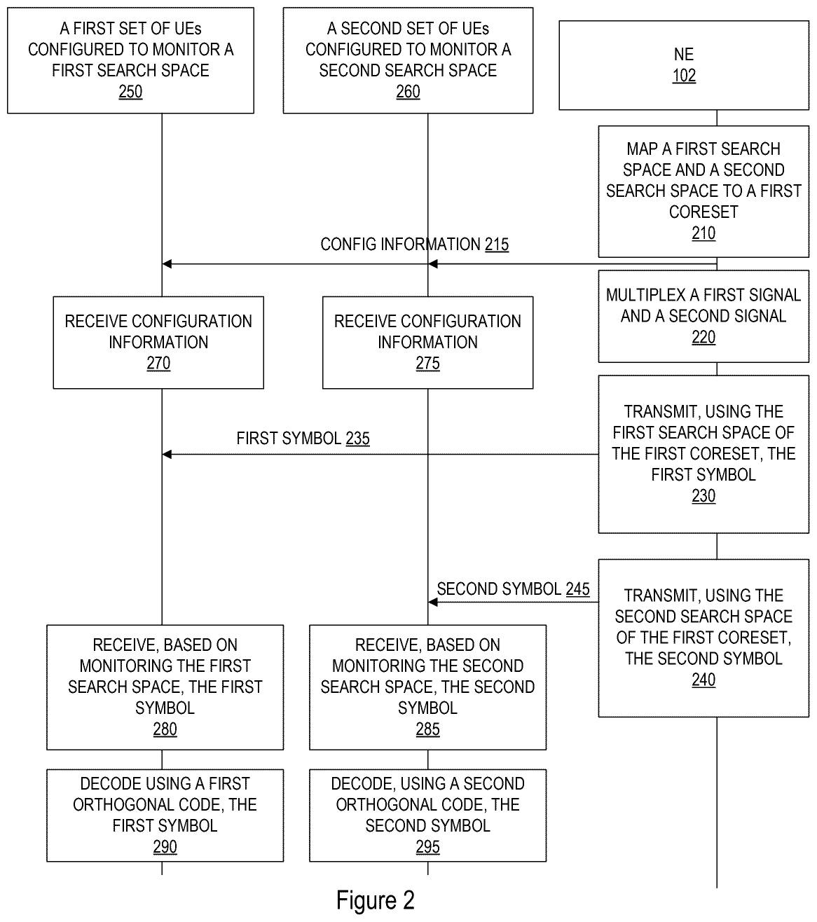

FIG. 2 illustrates a communication flow diagram for multiplexing a plurality of search spaces in a CORSET in accordance with aspects of the present disclosure. FIG. 2 will be discussed in conjunction with FIG. 1.

More specifically, at 210, the NE 102 can map a first search space and a second search space to a first CORESET. For example, the NE 102 can map a first search space group to the first CORESET, the first search space group can have a plurality of search spaces (e.g., first search space, the second search space, a third search space, and so on). Additionally, each search space in the first search space group is associated with a unique OCC.

Additionally, the NE 102 can transmit a configuration information 215 to a plurality of UEs (e.g., a first set of UEs 250, a second set of UEs 260). For example, the configuration information 215 can be a PDCCH configuration that is configured by the NE 102. The configuration information 215 can include an first orthogonal cover code for the first search space and a second orthogonal cover code for the second search space.

At 220, the NE 102 can multiplex, using a code-division multiplexing technique, a first symbol 235 and a second symbol 245. The NE 102 can transmit the first symbol 235 in the first search space of the first CORESET. The NE 102 can transmit the second symbol 245 in the second search space of the first CORESET. The first symbol 235 can be a first PDCCH symbol, a first CORESET symbol, a first search space symbol, and/or a first DCI symbol (e.g., first DCI codeword. The second symbol 245 can be a second PDCCH symbol, a second CORESET symbol, a second search space symbol, and/or a second DCI symbol (e.g., second DCI codeword). For instance, the first PDCCH symbol can be transmitted in the first search space of the first CORESET and the second PDCCH symbol can be transmitted in the second search space of the first CORESET.

In some instances, the multiplexing using the code-division multiplexing technique can include applying a first OCC to the first symbol 235 and applying a second OCC to the second symbol 245. In some examples, the multiplexing using the code-division multiplexing technique can include applying a first OCC to a first PDCCH symbol and applying a second OCC to a second PDCCH symbol. In some examples, the multiplexing using the code-division multiplexing technique can include applying a first OCC to a first DCI codeword and applying a second OCC to a second DCI codeword. In yet another example, the multiplexing using the code-division multiplexing technique can include applying a first OCC to a first CORESET symbol and applying a second OCC to a second CORESET symbol. In yet another example, the multiplexing using the code-division multiplexing technique can include applying a first OCC to a first search space symbol and applying a second OCC to a second search space symbol.

In some instances, the first symbol 235 and second symbol 245 are made orthogonal by using code-division multiplexing in a time domain. In some instances, the first symbol 235 and second symbol 245 are made orthogonal by using code-division multiplexing in a frequency domain. In some instances, the first symbol 235 and second symbol 245 are made orthogonal by using code-division multiplexing in a combination of a time domain and a frequency domain.

In some instances multiplexing using the code-division multiplexing technique can include multiplying the first symbol 235 with a first binary sequence and multiplying the second symbol 245 with a second binary sequence. The first binary sequence can be orthogonal to the second binary sequence.

In some instances, the first search space can include a plurality of overlapping CCE indices with the second search space, and the NE 102 can configure a bitmap. The bitmap can include a bit associated with each CCE index in the plurality of overlapping CCE indices. Moreover, the NE 102 can multiplex the first symbol 235 and the second symbol 245 using the bitmap.

At 230, the NE 102 can transmit, using the first search space of the first CORESET, the first symbol 235 to a first set of UEs 250 configured to monitor the first search space. The first symbol 235 can be a first PDCCH symbol, a first CORESET symbol, a first search space symbol, and/or a first DCI symbol (e.g., first DCI codeword). The UEs 104 described in FIG. 1 can be an example of the first set of UEs 250.

At 240, the NE can transmit, using the second search space of the first CORESET, the second symbol 245 to a second set of UEs 260 configured to monitor the second search space. The second symbol can be a second PDCCH symbol, a second CORESET symbol, a second search space symbol, and/or a second DCI symbol (e.g., second DCI codeword). The UEs 104 described in FIG. 1 can be an example of the second set of UEs 260.

According to some examples, where the first symbol 235 is transmitted using a first spatial beam and the second symbol 245 is transmitted using a second spatial beam, the NE 102 can map a first DMRS sequence associated with the first search space to a first antenna port and map a second DMRS sequence associated with the second search space to a second antenna port. The first DMRS sequence and the second DMRS sequence can be made orthogonal by using code-division multiplexing in a time domain, in a frequency domain, or in a combination of time and frequency domains.

According to some other examples, when the first symbol 235 and the second symbol 245 are transmitted using a first spatial beam, after multiplexing the first PDCCH symbol and the second PDCCH symbol, the NE 102 can map a first DMRS sequence to the first search space and map the first DMRS sequence to the second search space. The first DMRS sequence and the second DMRS sequence can be made orthogonal by using code-division multiplexing in a time domain, in a frequency domain, or in a combination of time and frequency domains.

At 270, the first set of UEs 250 can receive configuration information 215. The configuration information can indicate that a first search space and a second search space are mapped to a first CORESET. Additionally, the configuration information 215 can include a first orthogonal code for multiplexing a first symbol that is transmitted in the first search space and a second orthogonal code for multiplexing a second symbol that is transmitted in the second search space.

The configuration information 215 can be PDCCH configuration information, CORESET configuration information, or search space configuration information.

At 275, the second set of UEs 260 can receive configuration information 215. The configuration information can indicate that a first search space and a second search space are mapped to a first CORESET. Additionally, the configuration information 215 can include a first orthogonal code for multiplexing a first symbol that is transmitted in the first search space and a second orthogonal code for multiplexing a second symbol that is transmitted in the second search space.

At 280, the first set of UEs 250 can receive, based on monitoring the first search space, the first symbol 235.

At 285, the second set of UEs 260 can receive, based on monitoring the second search space, the second symbol 245.

At 290, the first set of UEs 250 can decode, using the first orthogonal code, the first symbol. In some instances, the configuration information 215 can include a number of occurrences where the first symbol is transmitted by a base station, and the first symbol is decoded using an OCC after the first symbol has been received the number of occurrences.

At 295, the second set of UEs 260 can decode, using the second orthogonal code, the second symbol. In some instances, the configuration information 215 can include a number of occurrences where the second symbol is transmitted by a base station, and the second symbol is decoded using an OCC after the second symbol has been received the number of occurrences.

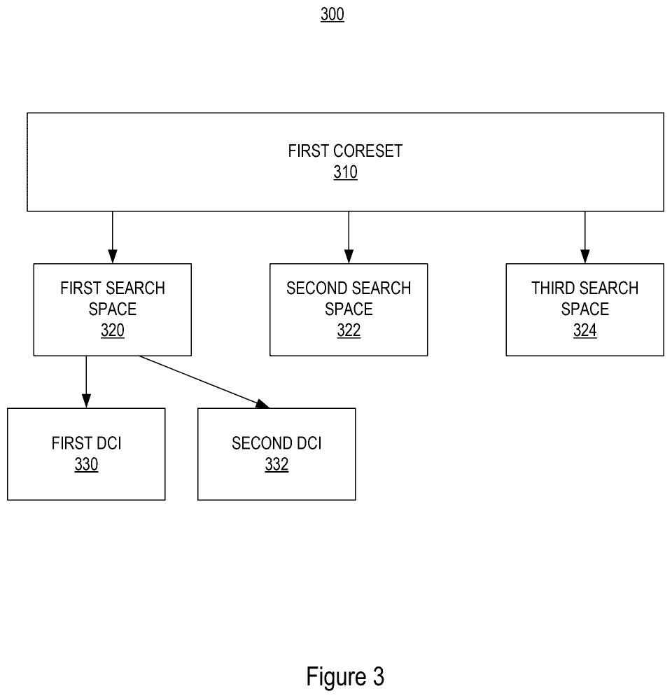

FIG. 3 illustrates an example mapping 300 of control resource allocation and signaling flow in a 5G NR system implementation in accordance with aspects of the present disclosure. The mapping 300 indicates hierarchical structure and potential allocation of control resources and signaling in a 5G NR system implementation. FIG. 3 will be discussed in conjunction with FIGS. 1 and 2.

For example, a plurality of search spaces (e.g., first search space 320, second search space 322, third search space 324, and so on) can be mapped to a first CORESET 310. Additionally, a plurality of DCI (e.g., a first DCI 330, a second DCI 332, and so on) can be mapped to each of the search spaces (e.g., a first search space 320) in the plurality of search spaces. As illustrated in the Figure includes a CORESET block 210, a plurality of search spaces—search space 0 312, search space 1 314, and search space x 316—and respective DCI entities 322 and 324 associated with search spaces 312 and 314. This Figure indicates hierarchical structure and potential allocation of control resources and signaling in a 5G NR system.

The first CORESET 310 can include a configurable group of time-frequency resources designated for the transmission of PDCCHs. For example, the first CORESET 310 can encompass one or more resource blocks and OFDM symbols within a NR slot and can be defined by network configuration for either common or UE-specific usage. The first CORESET 310 can be constructed to carry multiple PDCCH transmissions for one or more UEs, and can support flexible mapping of search spaces and aggregation levels as needed for different coverage or scheduling scenarios. In some implementations, the size, location, and structure of the first CORESET 310 can be configured by radio resource control (RRC) signaling or via dynamic MAC messages according to current network requirements.

The first search space 320, second search space 322, and third search space 324, can each include a collection of CCE indices or candidate sets within the first CORESET 310. The first search space 320 can be associated with a first set of UEs 250, the second search space 322 can be associated with the second set of UEs 260, and so on. Each search space can be configured for association with different types of control signaling or different UEs. For example, the first search space 320 can represent a common search space for system information or paging, the second search space 322 can correspond to a UE-specific search space for regular scheduling grants, and third search space 324 can be another instance for signaling fallback or enhanced coverage information. In some implementations, each search space can be assigned distinct time-frequency patterns, aggregation levels, or monitoring occasions. Additionally, each search space can be mapped to the same or overlapping regions within the first CORESET 310, subject to possible code-domain separation using, for example, orthogonal cover codes as described in some aspects of the disclosure.

The first DCI 330 can be associated with the first search space 320 and can be targeted to a first UE or first set of UEs (e.g., first set of UEs 250). For example, the first DCI 330 can carry scheduling assignments, resource grants, or control commands formatted in accordance with NR DCI standards, and mapped onto the CCEs indicated by the first search space 320. In some implementations, the first DCI 320 (e.g., first DCI codeword) can be encoded using a particular orthogonal code or code-division multiplexing technique when sharing the first CORESET 310 with other search spaces, as can be configured by network signaling.

The second DCI 332 can be associated with the first search space 320 and can be targeted to a second UE or second set of UEs (e.g., second set of UEs 260). The second DCI 332 can provide resource scheduling information, system configuration updates, or slot-format indicators, formatted for the search parameters of the first search space 320. In some implementations, the second DCI 332 can be transmitted concurrently with the first DCI 330 within overlapping or distinct CCEs of the first CORESET 310, with code-domain separation applied as needed to support multiplexed signaling.

Additional branches, such as the connection to the second search space 322 indicate that further search spaces and corresponding DCI can be defined and associated with the first CORESET 310.

In some implementations, the NE 102 can dynamically configure or adaptively manage the number and characteristics of search spaces and DCIs per CORESET based on scheduling demand, UE capabilities, or specific service requirements. The dynamic configuration allows flexible support for control channel multiplexing, dynamic search space allocation, and code-domain separation within a common resource set in compliance with the described aspects of the present disclosure.

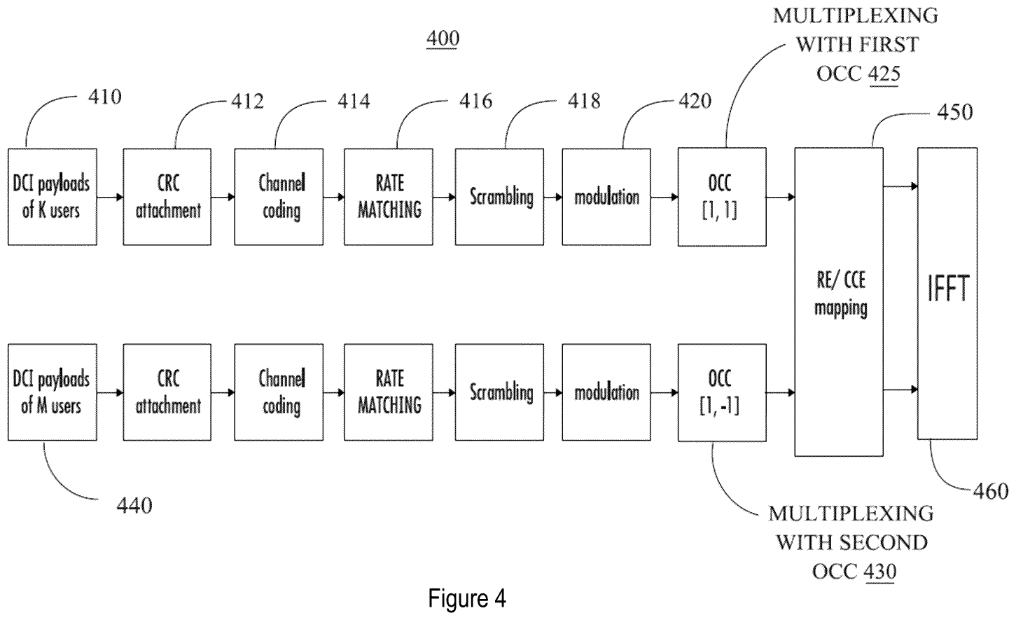

FIG. 4 illustrates an example dataflow implementation of PDCCH multiplexing with OCC in accordance with aspects of the present disclosure. The NE 102 (e.g., base station) can perform the operations described in dataflow implementation 400. The overall dataflow implementation 400 illustrates that DCI payloads from both K and M user sets are processed independently through standard control channel encoding procedures, then orthogonally multiplexed by applying distinct OCCs before being mapped to shared radio resources and transmitted as a composite signal. This approach allows flexible code-domain separation and simultaneous delivery of multiple control messages within a single CORESET without requiring non-overlapping allocation of physical resource elements.

The dataflow implementation 400 presents two parallel processing branches: one for DCI payload 410 of K users, and another for DCI payload 440 of M users. In both branches, digital control payloads are processed through sequential blocks labeled CRC attachment operation 412, channel coding operation 414, rate matching operation 416, scrambling operation 418, modulation operation 420, and multiplexing using different OCCs. The output of multiplexing using the first OCC 425 (e.g., OCC [1, 1]) in the upper branch and multiplexing using the second OCC 430 (e.g., OCC [1, −1]) in the lower branch are then mapped to shared radio resources via resource element mapping operation 450. The first OCC 425 and the second OCC 430 can be orthogonal to each other. Finally, the combined signals are transmitted through an inverse fast Fourier transform (IFFT) operation 460.

The DCI payloads 410 of K users can include DCI payloads for K users. For example, the DCI payloads 410 may comprise scheduling grants, control indicators, or system information addressed to up to K distinct UEs. In some implementations, the set of DCI payloads processed at this block can be dynamically selected per transmission occasion or predetermined per configuration. The DCI payloads 410 can be either common among users or specific per UE.

The DCI payloads 440 of M users can include DCI payloads for M users. For example, the DCI payloads 440 may comprise scheduling grants, control indicators, or system information addressed to up to M distinct UEs. In some implementations, the set of DCI payloads processed at this block can be dynamically selected per transmission occasion or predetermined per configuration. The DCI payloads 440 can be either common among users or specific per UE. The DCI payloads 440 can include DCI payloads targeting M users, processed in parallel to DCI payloads 410 of K. For example, the DCI payloads 440 can be used for another set of UEs or for repeated transmissions to the same or different devices, depending on the network schedule. The organization and construction of DCI payloads 440 can mirror that of DCI payloads 410, with payload format, CRC placement, coding, and scrambling determined from network signaling or static configuration.

The CRC attachment operation 412 in both processing branches can include logic to append a cyclic redundancy check (CRC) to each DCI payload, providing error-detection capability at the receiver. For example, the CRC attachment operation 412 can use a 16-bit or 24-bit CRC polynomial as specified by the NR standard, or another polynomial if required by system configuration. In some implementations, the CRC length or placement can be determined according to the DCI format or UE capability.

The channel coding operation 414 can include encoding logic to convert each payload with CRC into a coded bitstream according to a configurable channel coding scheme. For example, channel coding operation 414 can use polar codes for PDCCH, but may also employ turbo codes, LDPC, or other block or convolutional codes if desired. The channel coding block can dynamically adapt code rates or interleaving schemes based on network configuration or link adaptation procedures.

The rate matching operation 416 can include logic to adapt the number of coded bits to the available transmission resource elements. For instance, the rate matching operation 416 can use puncturing, repetition, or bit-interleaving techniques to fit the coded payload into the number of resource elements or CCEs allocated for the PDCCH. In some implementations, rate matching factors can be selected per scheduling grant, per UE, or per code rate requirement.

The scrambling operation 418 can include logic to randomize the bit patterns of each encoded payload, which can be accomplished by multiplying with a pseudo-random binary sequence. For example, the sequence can be derived from the cell ID, slot number, or UE-specific identifier. The scrambling operation 418 can minimize interference and improve signal properties for demodulation.

The modulation operation 420 can include logic to map scrambled bits to modulation symbols for physical transmission. In some examples, QPSK modulation is applied to the PDCCH, resulting in complex-valued symbols. In other implementations, higher or lower order modulations can be selected for specialized scenarios.

For the upper branch, the NE 102 can perform a multiplexing operation using a first OCC 425. In one example, the first OCC 425 can be a 2-length code, such as [1, 1]. In this example, the NE 102 can multiply the upper branch modulation symbols (e.g., output from the modulation operation 420) by [1, 1], thereby spreading or coding the modulated signal to enforce code-domain orthogonality. For example, the first OCC 425 can use a 2-length code, or may use longer orthogonal sequences depending on system configuration. The multiplexing using the first OCC 425 can be implemented with matrix multiplication, sequence generation, or lookup tables, and can support Walsh, Hadamard, or custom orthogonal sequence types.

For the lower branch, the NE 102 can perform a multiplexing operation using a second OCC 430. Continuing with the previous example, the second OCC 430 can be 2-length code, such as [1, −1]. The NE 102 can multiply the lower branch modulation symbols (e.g., output from the modulation operation in the lower branch) by [1, −1]. For example, this code is mutually orthogonal to [1, 1] and enables separation of the lower branch signal from the upper branch at the receiver. The multiplexing using the second OCC 430 can be implemented using sequence multiplication, vector arithmetic, or finite-state processing, and its assignment can be configured by network protocol or dynamically per PDCCH scheduling instance.

The resource element mapping operation 450 can include a CCE mapping. During the resource element mapping operation 450, the NE 102 can map the OCC-coded symbols from both processing branches to designated physical resource elements within the time-frequency grid of the CORESET. For example, the mapping function can assign output symbols to resource elements according to the current CORESET configuration, ensuring that both OCC-multiplexed signals are superposed on the same set of resource elements. In some implementations, the resource element mapping operation 450 can be configured with overlap, offset, or bitmap-based allocation to permit flexible multiplexing arrangements.

During the IFFT operation 460, the NE 102 can perform an inverse fast Fourier transform on the output of the resource element mapping operation 450, converting the frequency-domain symbols into time-domain signals for OFDM transmission. For instance, the IFFT size can be set according to the subcarrier allocation and numerology of the CORESET, and can include 128, 256, 512, or other power-of-two point counts. The IFFT operation 460 can be integrated with digital baseband hardware or software processing pipelines prior to radio frequency up-conversion and antenna emission.

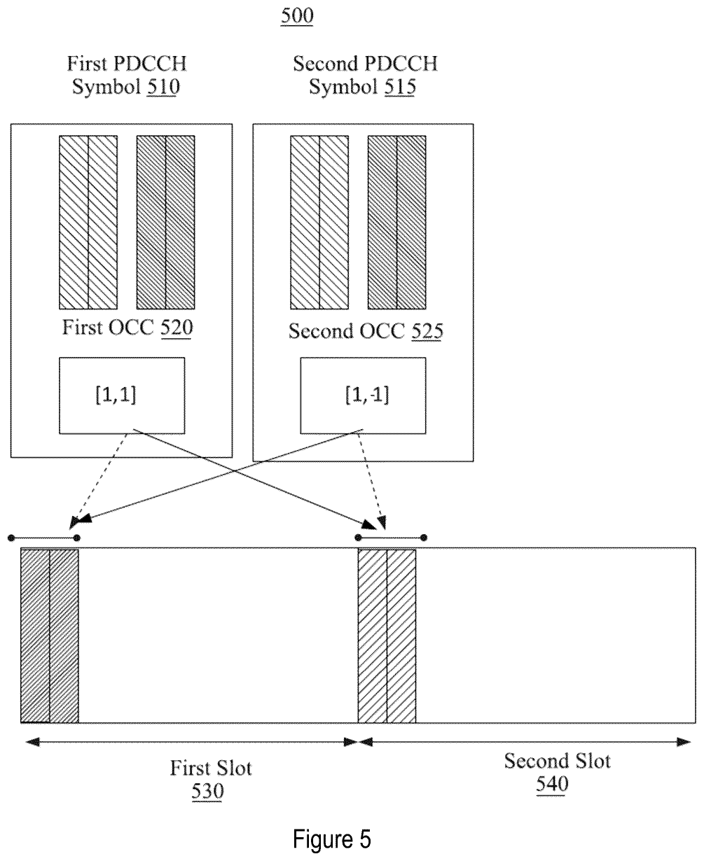

FIG. 5 illustrates an example inter-slot mapping example 500 in accordance with aspects of the present disclosure. FIG. 5 provides an example of how code-division multiplexing with OCC can be applied to PDCCH transmissions spanning differing time slots. The Figure depicts, by way of example, how the first PDCCH symbol 510 and second PDCCH symbol 515 are made orthogonal by using code-division multiplexing in a time domain. In the inter-slot mapping example 500, code-division multiplexing using OCCs can be applied to PDCCH symbol mapping in the time domain.

The NE 102 can configure a mapping type as part of the configuration information 215 (e.g., search space configuration, CORESET configuration, PDCCH configuration), thereby mapping the orthogonally multiplexed symbols into inter-slot time domain, intra-slot time domain or intra-slot frequency domain mapping.

In the inter-slot mapping example 500, a first PDCCH symbol 510 after spreading with a first OCC 520 and a second PDCCH symbol 515 after spreading with a second OCC 525 can be mapped using inter-slot contiguous or non-contiguous repetition depending on the search space monitoring configuration or PDCCH configuration. The first repeated PDCCH can be mapped in the first slot 530 and the second repeated PDCCHs can be mapped in the second slot 540.

In one implementation, when an OCC configuration is provided as part of the search space configuration, then the NE 102 can multiplex the PDCCH symbols 510, 515 with the corresponding OCCs 520, 525 and transmitted according to corresponding search space periodicity and symbols in a slot.

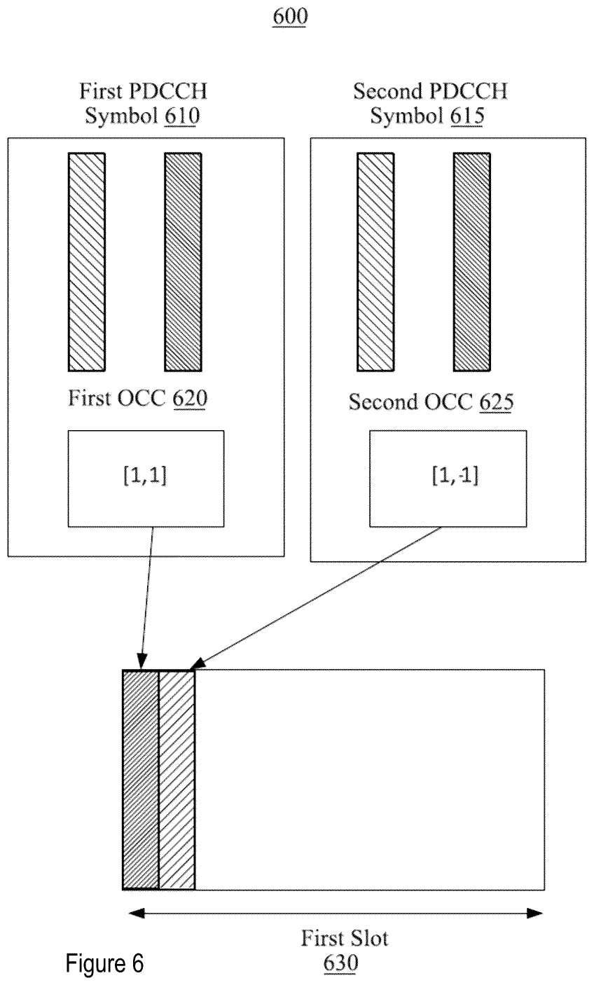

FIG. 6 illustrates an intra-slot mapping example 600 in accordance with aspects of the present disclosure. The Figure depicts, by way of example, how code-division multiplexing using OCCs can be applied to PDCCH symbol mapping within a single slot. In the intra-slot frequency domain mapping example 600, the first PDCCH symbol 610 and second PDCCH symbol 615 are made orthogonal by using code-division multiplexing in a frequency domain.

As previously mentioned, the NE 102 can configure a mapping type as part of the configuration information 215 (e.g., search space configuration, CORESET configuration, PDCCH configuration), thereby mapping the orthogonally multiplexed symbols into inter-slot time domain, intra-slot time domain or intra-slot frequency domain mapping.

In the intra-slot mapping example 600, a first PDCCH symbol 610 after spreading with a first OCC 620 and a second PDCCH symbol 615 after spreading with a second OCC 625 can be mapped in a first slot 630 using intra-slot mapping. The first slot 630 can indicate slot timing or OFDM symbol indices, and a first OCC-coded symbol 640 (e.g., output of first OCC 425 in FIG. 4) and a second OCC-coded symbol 645 (e.g., output of second OCC 430 in FIG. 4) can represent OCC-multiplexed PDCCH symbols transmitted together within the first slot 630. In some implementations, the mapping can support full superposition, so that both OCC-coded symbols 640, 645 are transmitted in the same OFDM symbols and subcarriers. In other implementations, the regions can partially overlap depending on allocation flexibility.

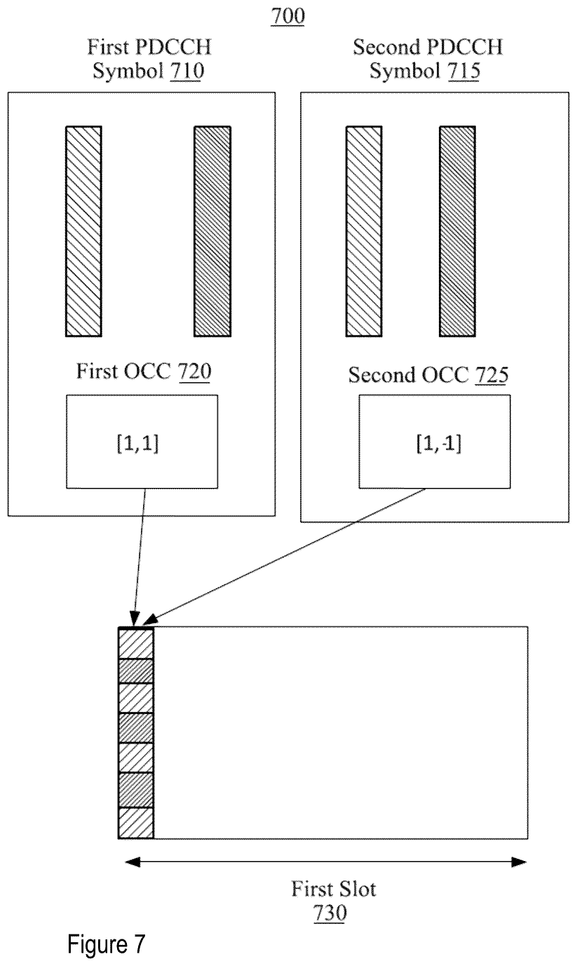

FIG. 7 illustrates an intra-slot frequency domain mapping example 700 in accordance with aspects of the present disclosure. In the intra-slot frequency domain mapping example 700, the first PDCCH symbol 710 and second PDCCH symbol 715 are made orthogonal by using code-division multiplexing in a combination of a time domain and a frequency domain.

In the intra-slot frequency mapping example 700, a first PDCCH symbol 710 after spreading with a first OCC 720 and a second PDCCH symbol 715 after spreading with a second OCC 725 can be mapped in a first slot 730 using intra-slot frequency domain mapping. Intra-slot frequency domain mapping is the method used to map signals (e.g., PDCCH or DMRS) across subcarriers within one slot.

In the PDCCH, the CORESET defines which RBs and OFDM symbols the control channel occupies. The control information is then mapped to CCEs which are spread over frequency using a resource mapping pattern. This mapping pattern can be: interleaved for frequency diversity or non-interleaved for simplicity and lower latency.

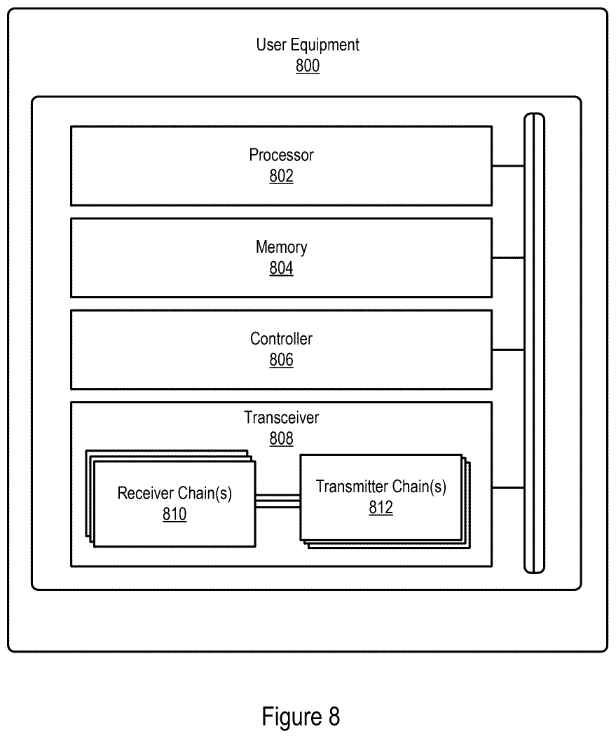

FIG. 8 illustrates an example of a UE 800 in accordance with aspects of the present disclosure. The UE 800 may include a processor 802, a memory 804, a controller 806, and a transceiver 808. The processor 802, the memory 804, the controller 806, or the transceiver 808, or various combinations thereof or various components thereof may be examples of means for performing various aspects of the present disclosure as described herein. These components may be coupled (e.g., operatively, communicatively, functionally, electronically, electrically) via one or more interfaces.

The processor 802, the memory 804, the controller 806, or the transceiver 808, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 802 may include an intelligent hardware device (e.g., a general-purpose processor, a DSP, a CPU, an ASIC, an FPGA, or any combination thereof). In some implementations, the processor 802 may be configured to operate the memory 804. In some other implementations, the memory 804 may be integrated into the processor 802. The processor 802 may be configured to execute computer-readable instructions stored in the memory 804 to cause the UE 800 to perform various functions of the present disclosure.

The memory 804 may include volatile or non-volatile memory. The memory 804 may store computer-readable, computer-executable code including instructions when executed by the processor 802 cause the UE 800 to perform various functions described herein. The code may be stored in a non-transitory computer-readable medium such the memory 804 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 802 and the memory 804 coupled with the processor 802 may be configured to cause the UE 800 to perform one or more of the functions described herein (e.g., executing, by the processor 802, instructions stored in the memory 804). For example, the processor 802 may support wireless communication at the UE 800 in accordance with examples as disclosed herein. The UE 800 may be configured to support a means for receiving configuration information, the configuration information indicates that a first search space and a second search space are mapped to a first CORESET spanning a first set of time-frequency resources corresponding to a PDCCH that carries a plurality of PDCCH symbols, and wherein the configuration information includes an orthogonal code for multiplexing a first PDCCH symbol that is transmitted in the first search space; receiving, based on monitoring the first search space, the first PDCCH symbol; and decoding, using the orthogonal code, the first PDCCH symbol.

The controller 806 may manage input and output signals for the UE 800. The controller 806 may also manage peripherals not integrated into the UE 800. In some implementations, the controller 806 may utilize an operating system such as iOS®, ANDROID®, WINDOWS®, or other operating systems. In some implementations, the controller 806 may be implemented as part of the processor 802.

In some implementations, the UE 800 may include at least one transceiver 808. In some other implementations, the UE 800 may have more than one transceiver 808. The transceiver 808 may represent a wireless transceiver. The transceiver 808 may include one or more receiver chains 810, one or more transmitter chains 812, or a combination thereof.

A receiver chain 810 may be configured to receive signals (e.g., control information, data, packets) over a wireless medium. For example, the receiver chain 810 may include one or more antennas for receive the signal over the air or wireless medium. The receiver chain 810 may include at least one amplifier (e.g., a low-noise amplifier (LNA)) configured to amplify the received signal. The receiver chain 810 may include at least one demodulator configured to demodulate the receive signal and obtain the transmitted data by reversing the modulation technique applied during transmission of the signal. The receiver chain 810 may include at least one decoder for decoding the processing the demodulated signal to receive the transmitted data.

A transmitter chain 812 may be configured to generate and transmit signals (e.g., control information, data, packets). The transmitter chain 812 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 812 may also include at least one power amplifier configured to amplify the modulated signal to an appropriate power level suitable for transmission over the wireless medium. The transmitter chain 812 may also include one or more antennas for transmitting the amplified signal into the air or wireless medium.

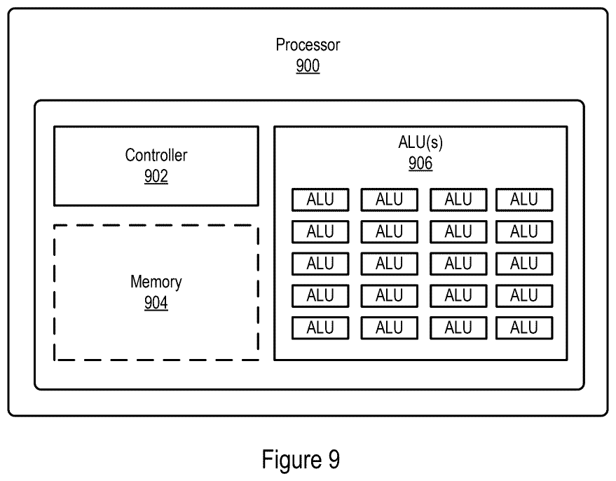

FIG. 9 illustrates an example of a processor 900 in accordance with aspects of the present disclosure. The processor 900 may be an example of a processor configured to perform various operations in accordance with examples as described herein. The processor 900 may include a controller 902 configured to perform various operations in accordance with examples as described herein. The processor 900 may optionally include at least one memory 904, which may be, for example, an L1/L2/L3 cache. Additionally, or alternatively, the processor 900 may optionally include one or more arithmetic-logic units (ALUs) 906. One or more of these components may be in electronic communication or otherwise coupled (e.g., operatively, communicatively, functionally, electronically, electrically) via one or more interfaces (e.g., buses).

The processor 900 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 900) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 902 may be configured to manage and coordinate various operations (e.g., signaling, receiving, obtaining, retrieving, transmitting, outputting, forwarding, storing, determining, identifying, accessing, writing, reading) of the processor 900 to cause the processor 900 to support various operations in accordance with examples as described herein. For example, the controller 902 may operate as a control unit of the processor 900, generating control signals that manage the operation of various components of the processor 900. These control signals include enabling or disabling functional units, selecting data paths, initiating memory access, and coordinating timing of operations.

The controller 902 may be configured to fetch (e.g., obtain, retrieve, receive) instructions from the memory 904 and determine subsequent instruction(s) to be executed to cause the processor 900 to support various operations in accordance with examples as described herein. The controller 902 may be configured to track memory address of instructions associated with the memory 904. The controller 902 may be configured to decode instructions to determine the operation to be performed and the operands involved. For example, the controller 902 may be configured to interpret the instruction and determine control signals to be output to other components of the processor 900 to cause the processor 900 to support various operations in accordance with examples as described herein. Additionally, or alternatively, the controller 902 may be configured to manage flow of data within the processor 900. The controller 902 may be configured to control transfer of data between registers, arithmetic logic units (ALUs), and other functional units of the processor 900.

The memory 904 may include one or more caches (e.g., memory local to or included in the processor 900 or other memory, such RAM, ROM, DRAM, SDRAM, SRAM, MRAM, flash memory, etc. In some implementations, the memory 904 may reside within or on a processor chipset (e.g., local to the processor 900). In some other implementations, the memory 904 may reside external to the processor chipset (e.g., remote to the processor 900).

The memory 904 may store computer-readable, computer-executable code including instructions that, when executed by the processor 900, cause the processor 900 to perform various functions described herein. The code may be stored in a non-transitory computer-readable medium such as system memory or another type of memory. The controller 902 and/or the processor 900 may be configured to execute computer-readable instructions stored in the memory 904 to cause the processor 900 to perform various functions. For example, the processor 900 and/or the controller 902 may be coupled with or to the memory 904, the processor 900, the controller 902, and the memory 904 may be configured to perform various functions described herein. In some examples, the processor 900 may include multiple processors and the memory 904 may include multiple memories. One or more of the multiple processors may be coupled with one or more of the multiple memories, which may, individually or collectively, be configured to perform various functions herein.

The one or more ALUs 906 may be configured to support various operations in accordance with examples as described herein. In some implementations, the one or more ALUs 906 may reside within or on a processor chipset (e.g., the processor 900). In some other implementations, the one or more ALUs 906 may reside external to the processor chipset (e.g., the processor 900). One or more ALUs 906 may perform one or more computations such as addition, subtraction, multiplication, and division on data. For example, one or more ALUs 906 may receive input operands and an operation code, which determines an operation to be executed. One or more ALUs 906 be configured with a variety of logical and arithmetic circuits, including adders, subtractors, shifters, and logic gates, to process and manipulate the data according to the operation. Additionally, or alternatively, the one or more ALUs 906 may support logical operations such as AND, OR, exclusive-OR (XOR), not-OR (NOR), and not-AND (NAND), enabling the one or more ALUs 906 to handle conditional operations, comparisons, and bitwise operations.

The processor 900 may support wireless communication in accordance with examples as disclosed herein. The processor 900 may be configured to or operable to support a means for mapping a first search space and a second search space to a first CORESET spanning a first set of time-frequency resources corresponding to a physical downlink control channel (PDCCH) that carries a plurality of PDCCH symbols; multiplexing, using a code-division multiplexing technique, a first PDCCH symbol and a second PDCCH symbol, wherein the first PDCCH symbol is to be transmitted in the first search space of the first CORESET and the second PDCCH symbol is to be transmitted in the second search space of the first CORESET; transmitting, using the first search space of the first CORESET, the first PDCCH symbol to a first set of UEs configured to monitor the first search space; and transmitting, using the second search space of the first CORESET, the second PDCCH symbol to a second set of UEs configured to monitor the second search space.

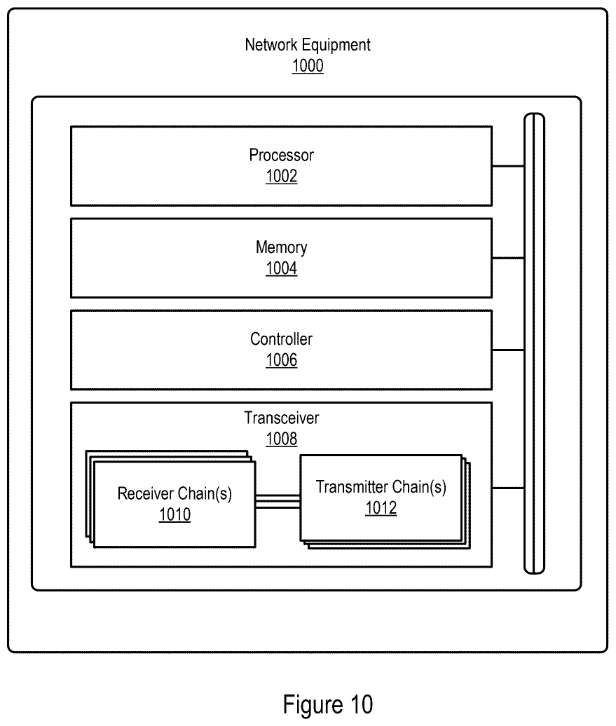

FIG. 10 illustrates an example of a NE 1000 in accordance with aspects of the present disclosure. The NE 1000 may include a processor 1002, a memory 1004, a controller 1006, and a transceiver 1008. The processor 1002, the memory 1004, the controller 1006, or the transceiver 1008, or various combinations thereof or various components thereof may be examples of means for performing various aspects of the present disclosure as described herein. These components may be coupled (e.g., operatively, communicatively, functionally, electronically, electrically) via one or more interfaces.

The processor 1002, the memory 1004, the controller 1006, or the transceiver 1008, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1002 may include an intelligent hardware device (e.g., a general-purpose processor, a DSP, a CPU, an ASIC, an FPGA, or any combination thereof). In some implementations, the processor 1002 may be configured to operate the memory 1004. In some other implementations, the memory 1004 may be integrated into the processor 1002. The processor 1002 may be configured to execute computer-readable instructions stored in the memory 1004 to cause the NE 1000 to perform various functions of the present disclosure.

The memory 1004 may include volatile or non-volatile memory. The memory 1004 may store computer-readable, computer-executable code including instructions when executed by the processor 1002 cause the NE 1000 to perform various functions described herein. The code may be stored in a non-transitory computer-readable medium such the memory 1004 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1002 and the memory 1004 coupled with the processor 1002 may be configured to cause the NE 1000 to perform one or more of the functions described herein (e.g., executing, by the processor 1002, instructions stored in the memory 1004). For example, the processor 1002 may support wireless communication at the NE 1000 in accordance with examples as disclosed herein. The NE 1000 may be configured to support a means for mapping a first search space and a second search space to a first CORESET spanning a first set of time-frequency resources corresponding to a physical downlink control channel (PDCCH) that carries a plurality of PDCCH symbols; multiplexing, using a code-division multiplexing technique, a first PDCCH symbol and a second PDCCH symbol, wherein the first PDCCH symbol is to be transmitted in the first search space of the first CORESET and the second PDCCH symbol is to be transmitted in the second search space of the first CORESET; transmitting, using the first search space of the first CORESET, the first PDCCH symbol to a first set of UEs configured to monitor the first search space; and transmitting, using the second search space of the first CORESET, the second PDCCH symbol to a second set of UEs configured to monitor the second search space.

The controller 1006 may manage input and output signals for the NE 1000. The controller 1006 may also manage peripherals not integrated into the NE 1000. In some implementations, the controller 1006 may utilize an operating system such as iOS®, ANDROID®, WINDOWS®, or other operating systems. In some implementations, the controller 1006 may be implemented as part of the processor 1002.

In some implementations, the NE 1000 may include at least one transceiver 1008. In some other implementations, the NE 1000 may have more than one transceiver 1008. The transceiver 1008 may represent a wireless transceiver. The transceiver 1008 may include one or more receiver chains 1010, one or more transmitter chains 1012, or a combination thereof.

A receiver chain 1010 may be configured to receive signals (e.g., control information, data, packets) over a wireless medium. For example, the receiver chain 1010 may include one or more antennas for receive the signal over the air or wireless medium. The receiver chain 1010 may include at least one amplifier (e.g., a low-noise amplifier (LNA)) configured to amplify the received signal. The receiver chain 1010 may include at least one demodulator configured to demodulate the receive signal and obtain the transmitted data by reversing the modulation technique applied during transmission of the signal. The receiver chain 1010 may include at least one decoder for decoding the processing the demodulated signal to receive the transmitted data.

A transmitter chain 1012 may be configured to generate and transmit signals (e.g., control information, data, packets). The transmitter chain 1012 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1012 may also include at least one power amplifier configured to amplify the modulated signal to an appropriate power level suitable for transmission over the wireless medium. The transmitter chain 1012 may also include one or more antennas for transmitting the amplified signal into the air or wireless medium.

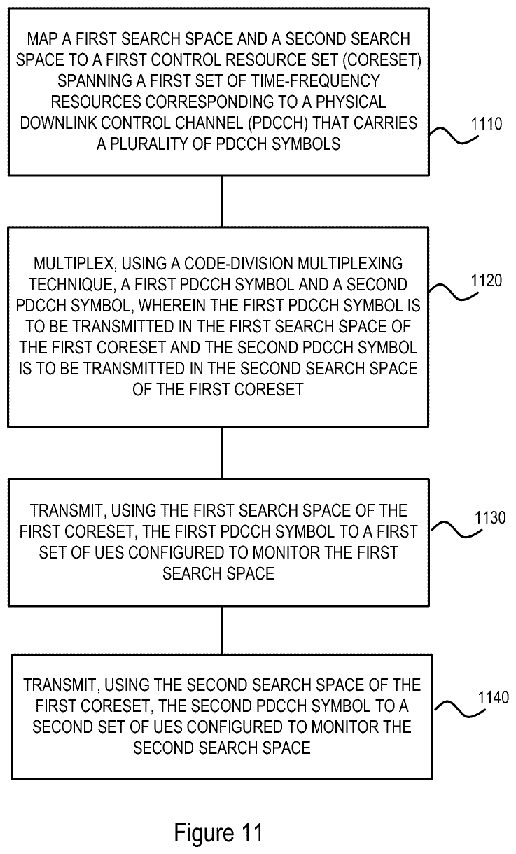

FIG. 11 illustrates a flowchart of a method in accordance with aspects of the present disclosure. The operations of the method may be implemented by a NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

Compared to prior solutions, such as repetition or aggregation-level increase without multiplexing, the present disclosure may improve the likelihood of successful PDCCH scheduling for multiple UEs under limited CORESET and CCE resources. For example, blocking due to CCE exhaustion can be reduced, control region utilization can be increased, and spectral efficiency can be improved by mapping more control messages into the same set of resources without increased collision risk. The technique can be flexibly combined with conventional scheduling, aggregation, and search space assignment methods, and can be adapted for both intra-slot and inter-slot OCC mapping scenarios.

In some implementations, one or more techniques depicted herein support dynamic adaptation of OCC assignment and multiplexing configurations based on current network load or per-user requirements. For example, the base station can monitor control channel utilization and adjust the set of OCCs in use, the number of multiplexed PDCCH instances, or the degree of overlap between search spaces to respond to variations in user density or traffic demands. The UE may be configured to adapt its monitoring behavior, DMRS demodulation logic, and search space decoding strategy based on the dynamic control signaling provided by the gNB, enabling it to keep up with evolving multiplexing and OCC assignments. The base station may update the configuration messages and send the updated configuration messages to the UEs. Additionally or alternatively, the base station may send dynamic scheduling indication, allowing the network to scale PDCCH capacity as needed. In some implementations, the base station can prioritize OCC-based multiplexing for coverage-challenged UEs or during periods of control channel congestion, while reverting to non-multiplexed operation under light load. This flexibility can allow the system to optimize control signaling efficiency by selectively invoking the described multiplexing processes according to network conditions and performance objectives.

At operation 1110, the method may include mapping a first search space and a second search space to a first CORESET spanning a first set of time-frequency resources corresponding to a PDCCH that carries a plurality of PDCCH symbols. The operations of 1110 may be performed in accordance with examples as described herein. In some implementations, aspects of the operations of 1110 may be performed by a NE as described with reference to FIG. 10.

For example, operation 1110 can comprise execution by a base station processor to identify a subset of available OFDM symbols and subcarriers and designate them for use as a CORESET. Within the designated CORESET, the processor can further assign indices or configuration parameters for two search spaces, defined as candidate regions in which PDCCH messages may be monitored by corresponding UEs. Each search space can be configured according to aggregation levels, resource element allocations, or monitoring occasions, and can correspond to distinct UEs, UE groups, or control signaling types, such as common, UE-specific, or coverage-enhancement search spaces.

In some instances, the base station can configure a PDCCH configuration. The PDCCH configuration can have an first OCC for the first search space and a second OCC for the second search space.

In some instances, the base station can map a first search space group to the first CORESET. The first search space group can have the first search space, the second search space, and a third search space. Additionally, each search space in the first search space group is associated with a unique OCC (e.g., first search space can be associated with a first OCC, second search space can be associated with a second OCC, third search space can be associated with a third OCC). Moreover, the base station can map a second search space group to a second CORESET. The second search space group can also have a plurality of search spaces. Furthermore, the first CORESET and the second CORESET can be transmitted in a first time slot.

At operation 1120, the method may include multiplexing, using a code-division multiplexing technique, a first PDCCH symbol and a second PDCCH symbol. The first PDCCH symbol can be transmitted in the first search space of the first CORESET and the second PDCCH symbol can be transmitted in the second search space of the first CORESET. The operations of 1120 may be performed in accordance with examples as described herein. In some implementations, aspects of the operations of 1120 may be performed by a NE as described with reference to FIG. 10.

For example, operation 1120 can involve applying a first OCC or other mutually orthogonal sequence to the first PDCCH symbol associated with the first search space, and a second OCC to the second PDCCH symbol associated with the second search space. The code-division multiplexing technique implemented in operation 1120 can operate in the time domain, frequency domain, or both. For example, each PDCCH symbol can be multiplied by its assigned OCC prior to mapping onto the CORESET resource grid, allowing the two PDCCH symbols to be transmitted simultaneously over the same physical resource elements while maintaining code-domain orthogonality. In some implementations, the code assignment can be selected from Walsh-Hadamard codes, Zadoff-Chu sequences, or quasi-orthogonal code families, with configuration parameters signaled through PDCCH or CORESET configuration fields.

In some instances, multiplexing using the code-division multiplexing technique can include applying a first orthogonal cover code (OCC) to the first PDCCH symbol and applying a second OCC to the second PDCCH symbol.

In some instances, the first PDCCH symbol can include a first downlink control information (DCI) codeword and the second PDCCH symbol includes a second DCI codeword. Additionally, multiplexing using the code-division multiplexing technique can include applying a first OCC to the first DCI codeword and applying a second OCC to the second DCI codeword.

In some instances, the first PDCCH symbol can include a first DCI codeword and the second PDCCH symbol can include a second DCI codeword. Additionally, multiplexing using the code-division multiplexing technique can include multiplying the first DCI codeword with a first binary sequence. Moreover, multiplexing using the code-division multiplexing technique can further include multiplying the second DCI codeword with a second binary sequence. Furthermore, the first binary sequence can be orthogonal to the second binary sequence.

In some instances, the first PDCCH symbol and second PDCCH symbol can be made orthogonal by using code-division multiplexing in a time domain.

In some instances, the first PDCCH symbol and second PDCCH symbol can be made orthogonal by using code-division multiplexing in a frequency domain.

In some instances, the first PDCCH symbol and the second PDCCH symbol can be made orthogonal by using code-division multiplexing in a combination of a time domain and a frequency domain.

In some implementations, a wireless communications device (e.g., UE or base station or both) may perform code-division multiplexing in various domains, such as the time domain, frequency domain, or a combination thereof. For instance, a base station can assign time-domain OCCs to different search spaces, such that overlapping PDCCH symbols are multiplexed within different orthogonal frequency division multiplexing (OFDM) symbols in a time slot. Alternatively, frequency-domain OCCs can be applied so that PDCCH symbols are orthogonally mapped across different frequency resources. The multiplexing configuration can also enable a flexible allocation by partially overlapping the CCEs used by different search spaces that can be determined based on bitmap signaling or resource subset configuration.

In some instances, the first search space can include a plurality of overlapping control channel element (CCE) indices with the second search space. Additionally, the base station can configure a bitmap. The bitmap can include a bit associated with each CCE index in the plurality of overlapping CCE indices. Moreover, multiplexing using the code-division multiplexing technique can include multiplexing the first PDCCH symbol and the second PDCCH symbol based on the bitmap.

In some instances, the first search space can include a plurality of CCE indices. Additionally, multiplexing using the code-division multiplexing technique can include multiplexing the first PDCCH symbol for a subset of the plurality of CCE indices in the first search space. Multiple search spaces can be grouped (e.g., using a search space group ID) and assigned unique OCCs for multiplexing within a single CORESET. According to one or more aspects depicted herein, one or more wireless communications devices may support partial or complete overlapping of the CCE resources, with the specific degree of overlap and code assignment determined by configuration. In some implementations, the network can configure which subset of search space monitoring occasions and CCEs are subject to OCC-based multiplexing.

At operation 1130, the method may include transmitting, using the first search space of the first CORESET, the first PDCCH symbol to a first set of UEs configured to monitor the first search space. The operations of 1130 may be performed in accordance with examples as described herein. In some implementations, aspects of the operations of 1130 may be performed by a NE as described with reference to FIG. 10.

For example, operation 1130 can cover the mapping of the code-domain-multiplexed first PDCCH symbol to designated time-frequency resources allocated by the CORESET and indicated for use by the first search space. The base station can then emit these resources over the air interface for reception by UEs operating in the coverage area. The first UE, corresponding to the first search space, can be configured to monitor the appropriate region of the CORESET for downlink control signaling, and decode PDCCH candidates by applying a de-spreading operation utilizing the OCC assigned to the first PDCCH symbol. Operation 1130 may include all baseband processing, synchronization, radio transmission, and protocol steps (e.g., as described in FIG. 4) to deliver the first PDCCH symbol to the first UE through the mapped control channel resource elements.

The configuration of code-division multiplexing and OCCs can be signaled by the base station as part of PDCCH configuration, CORESET configuration, or search space configuration. For example, each search space can have information indicating the type and length of the OCC to use. A plurality of PDCCH signals can be multiplexed using unique OCCs and transmitted to different set of UEs. When multiple PDCCH symbols are transmitted within the same CORESET, their orthogonality may improve their separation at the receiver, thereby allowing greater simultaneous control signaling density.

At operation 1140, the method may include transmitting, using the second search space of the first CORESET, the second PDCCH symbol to a second set of UEs configured to monitor the second search space. The operations of 1140 may be performed in accordance with examples as described herein. In some implementations, aspects of the operations of 1140 may be performed by a NE as described with reference to FIG. 10.

The actions in operation 1140 can be analogous to those described in operation 1130, but directed to a different set of time-frequency/PDCCH resources identified by the second search space (which may partially or completely overlap with the first search space) and targeted to a separate second UE. The second PDCCH symbol, previously encoded with its assigned OCC during the multiplexing operation, can be mapped to the appropriate resources as allocated by the CORESET configuration. The base station transmits these resources, enabling the second UE to perform monitoring and de-spreading according to the OCC configured for its search space, and thereby decode and extract its intended control information from the received signal. This process allows for simultaneous, code-division-separated delivery of multiple PDCCH messages to different UEs through a common set of CORESET resources and supports increased control channel capacity without necessitating non-overlapping physical allocation of resources.

In some implementations, a wireless communications device (e.g., base station) may multiplex DMRS sequences associated with different search spaces or beams. In some implementations, DMRS sequences for different search spaces within a CORESET can be made orthogonal using CDM (in the time, frequency, or both domains), allowing separation at the UE when the PDCCH symbols themselves are multiplexed by OCCs. Allowing separation at the UE enables the UE to distinguish and correctly decode the different PDCCH transmissions that may be transmitted simultaneously within the same CORESET. When DMRS sequences associated with different PDCCHs are made orthogonal, the UE can identify and isolate its intended signal even if multiple PDCCHs overlap in time and frequency. Based on the orthogonality of the DMRS sequences, the UE can filter out other PDCCHs not meant for it and focus on decoding the correct control message using the unique orthogonal DMRS pattern assigned to it. The orthogonality of the DMRS sequences prevent interference between overlapping control transmissions and ensure reliable decoding of downlink control information.

In some instances, the first PDCCH symbol can be transmitted using a first spatial beam and the second PDCCH symbol can be transmitted using a second spatial beam. Additionally, the base station can map a first demodulation reference signal (DMRS) sequence associated with the first search space to a first antenna port. Moreover, the base station can map a second DMRS sequence associated with the second search space to a second antenna port. In one example, the first DMRS sequence and the second DMRS sequence can be made orthogonal by using code-division multiplexing in a time domain. In another example, the first DMRS sequence and the second DMRS sequence can be made orthogonal by using code-division multiplexing in a frequency domain. In yet another example, the first DMRS sequence and the second DMRS sequence can be made orthogonal by using code-division multiplexing in a combination of a time domain and a frequency domain.

In some instances, the first PDCCH symbol and the second PDCCH symbol can be transmitted using a first spatial beam. Additionally, the base station can map a first DMRS sequence to the first search space after multiplexing the first PDCCH symbol and the second PDCCH symbol. Moreover, the base station can map the first DMRS sequence to the second search space.

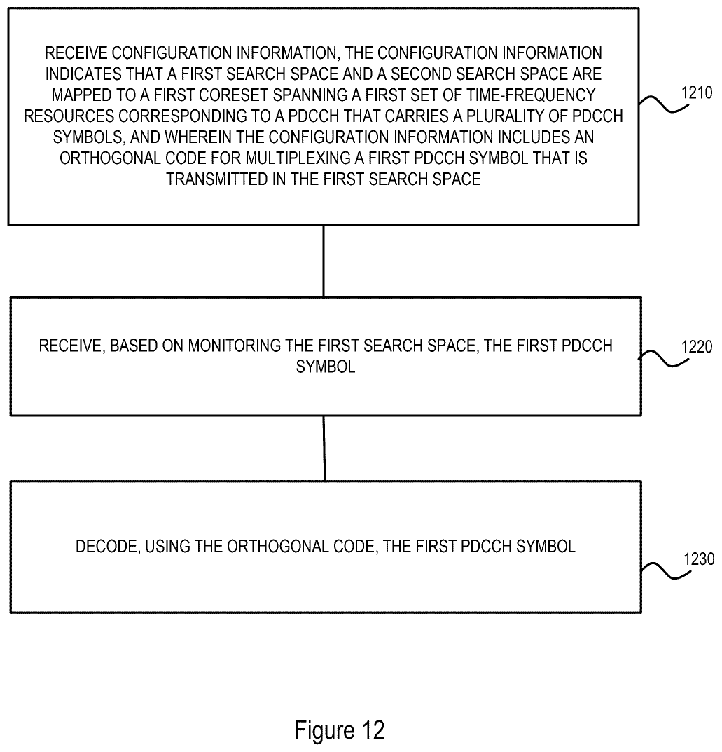

FIG. 12 illustrates a flowchart of a method in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

On the receiver side, the UE can be configured to receive and decode OCC-multiplexed PDCCH transmissions by performing de-spreading and separation of the different control channels assigned to the search spaces. For example, the UE may buffer symbols (e.g., CORESET, DMRS) received at operations 1130, 1140 and perform OCC-based de-spreading after receiving a configured number of repetitions or over a defined resource set. For example, in challenging coverage scenarios, the CORESET used for PDCCH transmission can be repeated, and the DMRS associated with the PDCCH can repeated to improve robustness and reliability of control decoding. This repetition helps UEs in poor radio conditions to better decode the PDCCH by increasing signal energy and enabling improved channel estimation. The UE can then perform blind decoding or other control channel search procedures on the separated control information corresponding to its configured search spaces and OCCs.

At operation 1210, the method may include receiving configuration information. The configuration information can indicate that a first search space and a second search space are mapped to a first CORESET spanning a first set of time-frequency resources corresponding to a PDCCH that carries a plurality of PDCCH symbols. Additionally, the configuration information can include an orthogonal code for multiplexing a first PDCCH symbol that is transmitted in the first search space. The operations of 1210 may be performed in accordance with examples as described herein. In some implementations, aspects of the operations of 1210 may be performed by a UE as described with reference to FIG. 8.

In some implementations, the configuration information can specify that the first CORESET comprises a set of time-frequency resources allocated for the transmission of PDCCH symbols. For example, the configuration information can reference time and frequency ranges notified to the UE via higher layer signaling or physical layer broadcasts. In some implementations, the configuration information can also indicate that an orthogonal code is included for multiplexing PDCCH transmissions, where the orthogonal code may be used to distinguish overlapping PDCCH symbols in different search spaces. The UE, at operation 1210, can process configuration elements such as PDCCH configuration messages, CORESET parameters, or search space configuration fields, each of which may be delivered through RRC, MAC control elements, or system information blocks. For instance, the UE may store details about the code sequences to be used (such as a specific orthogonal cover code from a Walsh or Gold sequence set), designate the aggregation levels and monitoring occasions, and record the scheduling of PDCCH repetition or code-division multiplexing parameters for future PDCCH processing.

In some instances, the configuration information can be PDCCH configuration information, CORESET configuration information, or search space configuration information.

At operation 1220, the method may include receiving, based on monitoring the first search space, the first PDCCH symbol. The operations of 1230 may be performed in accordance with examples as described herein. In some implementations, aspects of the operations of 1220 may be performed by a UE as described with reference to FIG. 8.

In some implementations, at operation 1220, the UE can access the time-frequency resources assigned to the first search space as indicated by the previously received configuration, and buffer or process the downlink signals corresponding to the PDCCH monitoring occasion. For example, the UE can refer to demodulating the received OFDM symbols within the designated time and frequency boundaries, de-mapping the physical resource elements corresponding to the allocated CCE indices, and storing received symbol streams for later de-spreading operations. In some implementations, the reception process performed by UE can include blind decoding, joint processing of PDCCH symbol repetitions, or selective combination of multiple occurrence signals, according to the configuration delivered through operation 1210.

At operation 1230, the method may include decoding, using the orthogonal code, the first PDCCH symbol. The operations of 1230 may be performed in accordance with examples as described herein. In some implementations, aspects of the operations of 1220 may be performed by a UE as described with reference to FIG. 8.

For example, operation 1230 can include applying the orthogonal code specified in configuration information to the received PDCCH symbol buffered in operation 1220. In some implementations, the UE can perform a de-spreading operation—such as multiplying received time- and/or frequency-domain samples by the orthogonal cover code and summing the results—to isolate the code-division multiplexed PDCCH symbol meant for the UE. For example, if the mapping indicates use of a Walsh sequence of length two, operation 1230 can multiply the received signal by [1, 1] or [1, −1], depending on the configured assignment, then process the resulting signal to extract DCI or schedule grant messages. In some implementations, operation 1230 can be performed after accumulating several repetitions if configured (e.g., when repetition-based coverage enhancement is applied), or after identifying that the monitored CCE subset corresponds to a code-division multiplexed group.

The outcome of operation 1230 can include candidate DCI codewords, control signaling blocks, or status messages for higher-layer protocol consumption.

In some instances, the configuration information can include a number of occurrences where the first PDCCH symbol is transmitted by a base station. Additionally, the UE can buffer the received symbols and wait to decode the first PDCCH symbol using an OCC after the first PDCCH symbol has been received the number of occurrences.

Each of the operations 1210, 1220, and 1230 can be physically implemented as logic in UE processors, firmware, or as modules in a software-defined radio stack. In some examples, operation 1210 can interface with the UE memory to store configuration parameters, operation 1220 can access hardware demodulators for symbol collection, and operation 1230 can perform mathematical operations for de-spreading and decoding as appropriate.

Aspects of the present disclosure are described in the context of a wireless communications system. Additionally details of one or more implementations of the present disclosure are set forth in the accompanying drawings and the description below. Other aspects and advantages will become apparent from the description, the drawings, and the claims.

The following provides an overview of aspects of the present disclosure:

Example 1 relates to method for wireless communication. The method can be performed by a base station. The method can include mapping a first search space and a second search space to a first CORESET spanning a first set of time-frequency resources corresponding to a PDCCH that carries a plurality of PDCCH symbols. Additionally, the method can include multiplexing, using a code-division multiplexing technique, a first PDCCH symbol and a second PDCCH symbol, wherein the first PDCCH symbol is to be transmitted in the first search space of the first CORESET and the second PDCCH symbol is to be transmitted in the second search space of the first CORESET. Moreover, the method can include transmitting, using the first search space of the first CORESET, the first PDCCH symbol to a first set of UEs configured to monitor the first search space. Furthermore, the method can include transmitting, using the second search space of the first CORESET, the second PDCCH symbol to a second set of UEs configured to monitor the second search space.

Example 2 includes the method of example 1. In this Example, the multiplexing using the code-division multiplexing technique can include: applying a first orthogonal cover code (OCC) to the first PDCCH symbol; and applying a second OCC to the second PDCCH symbol.

Example 3 includes the method of examples 1 or 2. In this Example, the first PDCCH symbol can include a first DCI codeword and the second PDCCH symbol includes a second DCI codeword, and the multiplexing using the code-division multiplexing technique can include applying a first OCC to the first DCI codeword and applying a second OCC to the second DCI codeword.

Example 4 includes the method of any of examples 1 to 3. In this Example, the first PDCCH symbol can include a first DCI codeword and the second PDCCH symbol can include a second DCI codeword. Additionally, the multiplexing using the code-division multiplexing technique can include: multiplying the first DCI codeword with a first binary sequence; and multiplying the second DCI codeword with a second binary sequence, and wherein the first binary sequence is orthogonal to the second binary sequence.

Example 5 includes the method of any of examples 1 to 4. In this Example, the first PDCCH symbol and second PDCCH symbol are made orthogonal by using code-division multiplexing in a time domain.

Example 6 includes the method of any of examples 1 to 4. In this Example, the first PDCCH symbol and second PDCCH symbol are made orthogonal by using code-division multiplexing in a frequency domain.

Example 7 includes the method of any of examples 1 to 4. In this Example, the first PDCCH symbol and the second PDCCH symbol are made orthogonal by using code-division multiplexing in a combination of a time domain and a frequency domain.

Example 8 includes the method of any of examples 1 to 7. In this Example, the method can include mapping a first search space group to the first CORESET, the first search space group having the first search space, the second search space, and a third search space, and wherein each search space in the first search space group is associated with a unique OCC.

Example 9 includes the method of example 8. In this Example, the method can include mapping a second search space group to a second CORESET, the second search space group having a plurality of search spaces, and wherein the first CORESET and the second CORESET are transmitted in a first time slot.

Example 10 includes the method of any of examples 1 to 9. In this Example, the first PDCCH symbol is transmitted using a first spatial beam and the second PDCCH symbol is transmitted using a second spatial beam. Additionally, the method can include mapping a first DMRS sequence associated with the first search space to a first antenna port. Moreover, the method can include map a second DMRS sequence associated with the second search space to a second antenna port.

Example 11 includes the method of example 10. In this Example, the first DMRS sequence and the second DMRS sequence are made orthogonal by using code-division multiplexing in a time domain.

Example 12 includes the method of example 10. In this Example, the first DMRS sequence and the second DMRS sequence are made orthogonal by using code-division multiplexing in a frequency domain.

Example 13 includes the method of any of examples 1 to 12. In this Example, the first PDCCH symbol and the second PDCCH symbol are transmitted using a first spatial beam. Additionally, the method can include mapping a first DMRS sequence to the first search space after multiplexing the first PDCCH symbol and the second PDCCH symbol. Moreover, the method can include mapping the first DMRS sequence to the second search space.

Example 14 includes the method of any of examples 1 to 13. In this Example, the first search space includes a plurality of overlapping control channel element (CCE) indices with the second search space. Additionally, the method can include configuring a bitmap, the bitmap includes a bit associated with each CCE index in the plurality of overlapping CCE indices. Moreover, the multiplexing using the code-division multiplexing technique further includes multiplexing the first PDCCH symbol and the second PDCCH symbol based on the bitmap.

Example 15 includes the method of any of examples 1 to 14. In this Example, the first search space includes a plurality of CCE indices. Additionally, the multiplexing using the code-division multiplexing technique further includes multiplexing the first PDCCH symbol for a subset of the plurality of CCE indices in the first search space.

Example 16 includes the method of any of examples 1 to 15. In this Example, the method can include configuring a PDCCH configuration, the PDCCH configuration having an first orthogonal cover code for the first search space and a second orthogonal cover code for the second search space.

Example 17 relates to a base station for wireless communication. The base station can include one or more memories; and one or more processors coupled with the one or more memories and individually or collectively operable to cause the base station to perform the method described in any of examples 1 to 16.

Example 18 relates to a processor comprising at least one controller coupled with at least one memory and configured to cause the processor to perform the method described in any of examples 1 to 16.

Example 19 relates to method for wireless communication. The method can be performed by a UE. The method can include receiving configuration information. The configuration information can indicate that a first search space and a second search space are mapped to a first CORESET spanning a first set of time-frequency resources corresponding to a PDCCH that carries a plurality of PDCCH symbols. Additionally, the configuration information can include an orthogonal code for multiplexing a first PDCCH symbol that is transmitted in the first search space. Moreover, the method can include receiving, based on monitoring the first search space, the first PDCCH symbol. Furthermore, the method can include decoding, using the orthogonal code, the first PDCCH symbol.

Example 20 includes the method of example 19. In this Example, the configuration information can be PDCCH configuration information, CORESET configuration information, or search space configuration information.

Example 21 includes the method of examples 19 or 20. In this Example, the configuration information can include a number of occurrences that the first PDCCH symbol is transmitted by a base station. Additionally, the first PDCCH symbol can be decoded using an OCC after the first PDCCH symbol has been received the number of occurrences.

Example 22 relates to a UE for wireless communication. The UE can include one or more memories; and one or more processors coupled with the one or more memories and individually or collectively operable to cause the UE to perform the method described in any of examples 19 to 21.

Example 23 relates to a processor comprising at least one controller coupled with at least one memory and configured to cause the processor to perform the method described in any of examples 19 to 21.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

The description provided herein, along with the accompanying figures, illustrates certain example implementations and is not intended to encompass all possible implementations within the scope of the claims. As used herein, the term “example” is intended to convey an illustration or instance, and does not imply a preferred or superior implementation. The detailed description includes specific features and elements to facilitate understanding of the implementations described in the present disclosure. However, these implementations may also be realized without some or all of the specified details.

What is claimed is:

1. A base station for wireless communication, comprising:
one or more memories; and
one or more processors coupled with the one or more memories and individually or collectively operable to cause the base station to:
map a first search space and a second search space to a first control resource set (CORESET) spanning a first set of time-frequency resources corresponding to a physical downlink control channel (PDCCH) that carries a plurality of PDCCH symbols;
multiplex, using a code-division multiplexing technique, a first PDCCH symbol and a second PDCCH symbol, wherein the first PDCCH symbol is to be transmitted in the first search space of the first CORESET and the second PDCCH symbol is to be transmitted in the second search space of the first CORESET;
transmit, using the first search space of the first CORESET, the first PDCCH symbol to a first set of user equipments (UEs) configured to monitor the first search space; and
transmit, using the second search space of the first CORESET, the second PDCCH symbol to a second set of UEs configured to monitor the second search space.

2. The base station of claim 1, wherein multiplexing using the code-division multiplexing technique further comprises:
applying a first orthogonal cover code (OCC) to the first PDCCH symbol; and
applying a second OCC to the second PDCCH symbol.

3. The base station of claim 1, wherein the first PDCCH symbol includes a first downlink control information (DCI) codeword and the second PDCCH symbol includes a second DCI codeword, and wherein multiplexing using the code-division multiplexing technique further comprises:
applying a first OCC to the first DCI codeword and applying a second OCC to the second DCI codeword.

4. The base station of claim 1, wherein the first PDCCH symbol includes a first DCI codeword and the second PDCCH symbol includes a second DCI codeword, and wherein multiplexing using the code-division multiplexing technique further comprises:
multiplying the first DCI codeword with a first binary sequence; and
multiplying the second DCI codeword with a second binary sequence, and wherein the first binary sequence is orthogonal to the second binary sequence.

5. The base station of claim 1, wherein the first PDCCH symbol and second PDCCH symbol are made orthogonal by using code-division multiplexing in a time domain.

6. The base station of claim 1, wherein the first PDCCH symbol and second PDCCH symbol are made orthogonal by using code-division multiplexing in a frequency domain.

7. The base station of claim 1, wherein the first PDCCH symbol and the second PDCCH symbol are made orthogonal by using code-division multiplexing in a combination of a time domain and a frequency domain.

8. The base station of claim 1, wherein the one or more processors cause the base station to:
map a first search space group to the first CORESET, the first search space group having the first search space, the second search space, and a third search space, and wherein each search space in the first search space group is associated with a unique OCC.

9. The base station of claim 8, wherein the one or more processors cause the base station to:
map a second search space group to a second CORESET, the second search space group having a plurality of search spaces, and wherein the first CORESET and the second CORESET are transmitted in a first time slot.

10. The base station of claim 1, wherein the first PDCCH symbol is transmitted using a first spatial beam and the second PDCCH symbol is transmitted using a second spatial beam, and wherein the one or more processors cause the base station to:
map a first demodulation reference signal (DMRS) sequence associated with the first search space to a first antenna port; and
map a second DMRS sequence associated with the second search space to a second antenna port.

11. The base station of claim 10, wherein the first DMRS sequence and the second DMRS sequence are made orthogonal by using code-division multiplexing in a time domain.

12. The base station of claim 10, wherein the first DMRS sequence and the second DMRS sequence are made orthogonal by using code-division multiplexing in a frequency domain.

13. The base station of claim 1, wherein the first PDCCH symbol and the second PDCCH symbol are transmitted using a first spatial beam, wherein the one or more processors cause the base station to:
map a first DMRS sequence to the first search space after multiplexing the first PDCCH symbol and the second PDCCH symbol; and
map the first DMRS sequence to the second search space.

14. The base station of claim 1, wherein the first search space includes a plurality of overlapping control channel element (CCE) indices with the second search space, and wherein the one or more processors cause the base station to:
configure a bitmap, the bitmap includes a bit associated with each CCE index in the plurality of overlapping CCE indices, and wherein multiplexing using the code-division multiplexing technique further comprises:
multiplexing the first PDCCH symbol and the second PDCCH symbol based on the bitmap.

15. The base station of claim 1, wherein the first search space includes a plurality of CCE indices, and wherein multiplexing using the code-division multiplexing technique further comprises:
multiplexing the first PDCCH symbol for a subset of the plurality of CCE indices in the first search space.

16. The base station of claim 1, wherein the one or more processors cause the base station to:
configure a PDCCH configuration, the PDCCH configuration having an first orthogonal cover code for the first search space and a second orthogonal cover code for the second search space.

17. A method performed or performable by a base station, the method comprising:
mapping a first search space and a second search space to a first control resource set (CORESET) spanning a first set of time-frequency resources corresponding to a physical downlink control channel (PDCCH) that carries a plurality of PDCCH symbols;
multiplexing, using a code-division multiplexing technique, a first PDCCH symbol and a second PDCCH symbol, wherein the first PDCCH symbol is to be transmitted in the first search space of the first CORESET and the second PDCCH symbol is to be transmitted in the second search space of the first CORESET;
transmitting, using the first search space of the first CORESET, the first PDCCH symbol to a first set of UEs configured to monitor the first search space; and
transmitting, using the second search space of the first CORESET, the second PDCCH symbol to a second set of UEs configured to monitor the second search space.

18. A user equipment (UE) for wireless communication, comprising:
one or more memories; and
one or more processors coupled with the one or more memories and individually or collectively operable to cause the UE to:
receive configuration information, the configuration information indicates that a first search space and a second search space are mapped to a first CORESET spanning a first set of time-frequency resources corresponding to a PDCCH that carries a plurality of PDCCH symbols, and wherein the configuration information includes an orthogonal code for multiplexing a first PDCCH symbol that is transmitted in the first search space;
receive, based on monitoring the first search space, the first PDCCH symbol; and
decode, using the orthogonal code, the first PDCCH symbol.

19. The UE of claim 18, wherein the configuration information is PDCCH configuration information, CORESET configuration information, or search space configuration information.

20. The UE of claim 18, wherein the configuration information includes a number of occurrences that the first PDCCH symbol is transmitted by a base station, and wherein the first PDCCH symbol is decoded using an orthogonal cover code (OCC) after the first PDCCH symbol has been received the number of occurrences.
